(19) United States
(12) Patent Application Publication
(10) Pub. No.: US 2014/0187570 A1
(43) Pub. Date: Jul. 3, 2014

(54) NOVEL FORMULATIONS OF PYRIMETHANIL, AND THEIR USE IN TREATMENT OF CROPS

(71) Applicant: Alberto Sardo, Chateaurenard (FR)

(72) Inventor: Alberto Sardo, Chateaurenard (FR)

(73) Assignee: XEDA INTERNATIONAL, SAINT ANDIOL (FR)

(21) Appl. No.: 13/824,664

(22) PCT Filed: Oct. 4, 2011
(86) PCT No.: PCT/FR11/52316

§ 371 Date: Mar. 18, 2013

(51) Int. Cl. A01N 43/54

(52) U.S. Cl. CPC A01N 43/54
USPC 514/275

(57) ABSTRACT

Solutions and emulsions of pyrimethanil and essential oils, and their use in fungicidal treatment of crops.

Pyrimethanil, 2-anilino-4,6-dimethylpyrimidine (CAS 53112-28-0), is a broad spectrum fungicide which is frequently used on crops, particularly grains. It particularly inhibits biosynthesis of methionine, thereby affecting the formation of proteins and the ultimate division of cells. However, pyrimethanil has a high vapour pressure, which limits its usefulness. Commercial formulations of pyrimethanil (Scala®) marketed by BASF contain about 37% by weight of pyrimethanil and 4 wt. % of sodium salts of sulphomethylated lignosulfonic acid, in the form of concentrated suspensions. The suspensions thus formed comprise particles having particle size between 5 and 50 microns, which is too large to provide satisfactory coating of fruits, vegetables, and grains, and which renders the commercial suspension of pyrimethanil poorly adapted to an application by thermonebulization, or sprinkling.

U.S. Pat. No. 6,030,977 proposes formulations of pyrimethanil with long chain fatty acids, thereby enabling reduction of the vapour pressure of pyrimethanil, providing better persistence of the active material on the crops, and also reducing the residue of the fungicide in the atmosphere.

Nonetheless it is still desirable to provide improved formulations of pyrimethanil which allow improved coating of crops and/or more versatile means of application.

Accordingly, according to one of the objects of the present invention, it has been discovered that the combination of pyrimethanil and one or more essential oils or active terpenic ingredients contained in such oils allows the solubilisation of pyrimethanil.

Thus, according to a first object, the invention concerns a solution of pyrimethanil characterised in that it comprises pyrimethanil and one or more essential oils and/or one or more active terpenic agents which are constituents of such oils.

In general, said solutions comprise:
between 5 and 40 wt. % of pyrimethanil;
between 10 and 95 wt. % of one or more essential oils and/or one or more active terpenic agents which are constituents of such oils.

In general, the solutions according to the invention may comprise one or more emulsifier(s).

According to a second object, the invention concerns an emulsion of pyrimethanil characterised in that it comprises pyrimethanil, one or more essential oils, and one or more active terpenic agents which are constituents of such oils, in emulsion in water.

The emulsion according to the invention may comprise the solution according to the invention, emulsified in water. The emulsion according to the invention, ready to use, may thus be prepared from the solution of the invention in concentrated form.

Generally, such emulsions comprise between 0.0025 and 2 wt. % of pyrimethanil, between 0.005 and 4.75 wt. % of one or more essential oils and/or active terpenic agents which are constituents of such oils, and between 93.25 and 99.9925 wt. % of water.

The formulations according to the invention comprise solutions and emulsions in water. The emulsions may comprise said solutions, mixed in water.

The term “essential oil” is understood to refer to any odorant product, generally of complex composition, obtained from a vegetable raw material, either by extraction by steam (e.g. in steam distillation) or by dry distillation, or by an appropriate mechanical technique without heating.

The essential oils are most often separated from the aqueous phase by a physical process in which their composition is not changed significantly. The preparation of the oils is carried out by methods known to one skilled in the art.

Among the essential oils, it can be cited in particular clove oil or peppermint oil; among the active terpenic agents which are constituents of such oils eugenol, iso-eugenol, and carvone can be cited.

The solutions according to the invention have the advantage of completely solubilising the pyrimethanil, thereby enabling one to produce readily an emulsion, by mixture with water, which emulsion is capable of very homogeneously coating crops, thereby providing improved exposure of the active ingredient, and enabling lower doses and lower residues.

The formulations according to the invention may also comprise of one or more solvents, such as propylene glycol, dipropylene glycol, di-isobutyl ketone, etc.

The formulations may also comprise of one or more emulsifying agents, ionic or non-ionic, such as non-ionic surfactants of the type of ethoxylated fatty acids, ethoxylated fatty alcohols, Tween 80, etc. These emulsifiers are per se known. In connection with the present invention, the term “emulsifier” is understood to mean any type of agent customarily used for the purpose of emulsification, such as ethoxylated fatty alcohols, ethoxylated fatty acids, ethoxylated alkylphenols, or any other non-ionic product.

The emulsifiers preferably used within the scope of the invention are anionic or non-ionic surfactants.

Examples of non-ionic surfactants which may be used according to the invention are the products of condensation of an aliphatic fatty alcohol, preferably C₈-C₂₂, with an alkylene oxide (C₂-C₃). The C₂-C₃ alkylene oxide may be ethylene oxide, propylene oxide, or a mixture of these in any proportion. An example of the surfactants is the product of condensation of lauryl alcohol (n-dodecyl alcohol) with 30 moles of ethylene oxide.

The non-ionic emulsifiers include, as examples, sugar esters, ethoxylated sorbitan monooleate, ethoxylated fatty acids, lecithin, esterified fatty acids such as glyceryl oleate, and mixtures of these.

The invention is not limited to the use of these particular emulsifiers.

The solutions according to the invention may additionally comprise from 0 to 85 wt. % of one or more wetting agents and/or solvents, such as monopropylene glycol or dipropylene glycol.

The solutions according to the invention may thus be suited for direct application to crops, particularly in storage spaces for fruits such as apples, root crops such as potatoes, or in grain silos, and other repositories for grains, cereals, and oilseeds.

According to another aspect, the solutions of the invention may be diluted in emulsion in water. For this purpose, the solutions may also comprise, in addition to the pyrimethanil and the essential oils and/or active terpenic agents which are constituents of such oils, one or more emulsifiers, such as non-ionic or ionic emulsifiers such as described above.

In general, the described non-ionic emulsifiers are present in the amount of 30 to 80 wt. %. Such a solution is referred to as an “emulsifiable water solution”, or “emulsifiable concentrate” (EC). These materials may be advantageously used in the orchard or the like, or post-harvest, after dilution in water. An EC formulation is generally diluted to 0.05-5 wt. % in water, preferably between 0.1 and 1%, particularly preferably about 0.25%, in the case of an EC formulation containing about 20 wt. % pyrimethanil.

In general, the concentration of pyrimethanil in such an emulsion is comprised between 100 and 5000 g/m³.

The emulsions according to the invention may be prepared by mixing a solution or emulsifiable formulation according to the invention in water, or by direct mixture of each of their constituents.

The invention also relates to a kit comprising pyrimethanil and one or more essential oils and/or one or more active terpenic agents which are constituents of such oils, for simultaneous application.

The kit may also comprise the following:
water; and/or
one or more emulsifier(s).

The kit is suitable for the treatment process according to the invention.

The formulations according to the invention are suitable for fungicidal treatment of crops. Said treatment is particularly advantageous in that, beyond the solubilising effect of the essential oils or active terpenic agents which are constituents of such oils, the oils and/or active terpenic agents themselves have a fungicidal effect.

Therefore the formulations according to the invention enable one to enhance the fungicidal effect while at the same time improving the quality of coating and thus potentiating the fungicidal activity of pyrimethanil.

The term “crop” is here understood to mean fruits and vegetables in the orchard or field, or after harvesting, dry fruits, dry vegetables, cereals, oilseeds, and particularly apples, bulbs, roots, and cereals.

Thus the invention also relates to fungicidal treatment of crops by application of a formulation according to the invention as described above. The treatment may be carried out via application by thermonebulization, sprinkling and/or immersion.

Thermonebulization is preferably used for application of a solution or emulsifiable formulation to a crop after harvesting or in a dry state.

In the course of thermonebulization, the solution or emulsifiable formulation is generally applied at a temperature comprised between 150 and 250° C. This technique is per se known, and is described in FR 98 015305 and FR 99 04534.

Thermonebulization is a method consisting of applying an extremely fine mist (in which the droplets have a size on the order of one micron), produced by injection of a liquid into a hot air flow which serves as a vehicle for the treating composition. The fog (mist) thus produced allows homogeneous application. Fogging may advantageously be carried out with the use of a fogging apparatus such as described in FR 87 04 960 or [sic] marketed under the trade name Electrofog Xeda®. This electric fogging machine is comprised of a high pressure blower, an electrical resistance, and a volumetric pump which provides strict regularity of the characteristics of the fog produced, and very progressive introduction of the treating composition into the charging chamber. In a classic technique, the conditions which allow the production of droplets of size from 0.5 to 10 microns, in particular on the order of one micron, which is characteristic of a thermospraying fog, comprise heating of the air to a temperature between 400 to 650° C. prior to injection of the liquid. The temperature of the fog exiting the thermospraying apparatus is advantageously chosen to be between 110 and 300° C., preferably between 150 and 260° C., for example between 170 and 250° C. This variable is more precisely described in FR 94 15 329.

Thermonebulization is particularly suitable for application of the solution or emulsifiable formulation. It is also suitable for oils and active ingredients which are somewhat volatile, such as peppermint oil, for example.

The application by dispersion or immersion is generally accomplished using the emulsion according to the invention. This application is particularly suitable for application in an orchard or field, or post-harvest. It is particularly suitable for application of clove oil.

The treatment process according to the invention is particularly suitable for the application of pyrimethanil in doses between 2 and 20 g/tonne of fruits, particularly about 0.05%, i.e. 500 ppm.

Surprisingly, treatment according to the invention allows one to broaden the spectrum of activity of the fungicide. Thus, the method according to the invention allows one to control certain fungi against which pyrimethanil itself is inactive or only weakly active.

In particular, it is known that pyrimethanil generates resistance in certain species. Combination with the essential oils or active agents which are constituents of such oils thus allows one to target these resistant fungi without giving rise to resistance.

The following examples are offered for illustrative purposes only, and do not limit the scope of the invention.

### EXAMPLE 1

### Formulation for Direct Application

An emulsifiable formulation is prepared with the following constituents:

| | |
|---|---|
| Pyrimethanil | 16 wt. % |
| Peppermint oil | 30 wt. % |
| Mono- and di-propylene glycol | 49 wt. % |
| Ethoxylated lauric acid 11 moles | 5 wt. %. |

A solution is obtained.

### EXAMPLE 2

### Formulation which is Emulsifiable in Water (EC)

An emulsifiable formulation is prepared with the following constituents:

| | |
|---|---|
| Pyrimethanil | 20 wt. % |
| Eugenol | 15 wt. % |
| Non-ionic emulsifier mixture | 65 wt. % |

A solution is obtained.

### EXAMPLE 3

The formulation according to Example 1 is applied in a fruit storage space with a dose of 50 g of the formulation according to Example 1 (i.e. 8 g pyrimethanil) per tonne of fruit.

The application is carried out with an “Electrofog” thermoelectric machine, at an exit temperature of 190° C.

The solution obtained results in a fine particle mist suitable for providing a high quality coating.

### EXAMPLE 4

The formulation according to Example 2 is diluted in water, as follows:
2.5 kg of the formulation according to Example 2 in one cubic metre of water, providing 500 g pyrimethanil per cubic meter of water, for application in an orchard; or
250 g of the formulation according to Example 2 in one cubic metre of water, providing 50 g pyrimethanil per cubic metre of water, for application post-harvest.

The emulsions thus obtained are applied to fruits by spraying or immersion of the crates, or by spraying with a spray brush [sic] in the case of fruits in crates.

### EXAMPLE 5

The fungicidal activity is demonstrated as follows:

Oranges are separated into three lots, and are treated as follows:
Lot 1 (control): oranges not treated;
Lot 2: oranges treated with pyrimethanil alone;
Lot 3: oranges treated with 250 g of the formulation according to Example 2 diluted in one hectolitre of water.

Lot 3 shows a reduction of the fungus Geotrichum candidum by 50%, whereas Lot 2 shows the same level of Geotrichum candidum as the control lot.

### EXAMPLE 6

Navel oranges were harvested on Jan. 18, 2011 and were inoculated the next day with strains of Penicillium digitatum.

| | Active | Application | | | | | |
|---|---|---|---|---|---|---|---|
| Treatment | substance | dose | | 01/19 | 01/26 | 02/02 | 02/09 |
| Control | | | PESINC | 0 | 100 | 100 | 100 |
| | | | PESEV | 0 | 19 | 42 | 75 |
| Xedathane 20 | 192 g/L | 250 g/h | PESINC | 0 | 7.5 | 12.5 | 28 |
| | pyrimethanil | | PESEV | 0 | 0.7 | 2.7 | 12.5 |
| Xedathane 20/16 | 192 g/L | 250 g/h | PESINC | 0 | 0 | 1.2 | 3.5 |
| | pyrimethanil | | PESEV | 0 | 0 | 0.2 | 1.4 |
| | 160 g/L eugenol | | | | | | |
| Bioxeda | 180 g/L eugenol | 1000 g/h | PESINC | 0 | 50 | 56 | 88 |
| | | | PESEV | 0 | 8.2 | 20 | 35 |

PESINC = % of fruits with presence of spores.
PESEV = % of surface covered by spores.

These results show that there is not just a simple additive effect of the activity of pyrimethanil and eugenol, but that there is a synergistic effect.

### EXAMPLE 8

### Evaluation of the In Vitro Efficacy of Combination according to the Invention against Phytopathogenic Microorganisms

### Object of the Study:

The object of the study was to determine the efficacy of combinations according to the invention against the phytopathogenic fungus Monilinia fructicola, compared to pyrimethanil alone.

The efficacy of the combinations against Monilinia fructicola was determined by determining the inhibition of growth of the halo in accordance with various general methods (ISO 6887: 2003; ISO 7218: 2007; ISO 7954: 1987).

### Samples Tested:

| | Active | Content of active | Type of |
|---|---|---|---|
| Treatment | ingredient(s) | ingredient | formulation |
| Xedathane 20 | Pyrimethanil | 20% | EC |
| Bioxeda | Clove oil | 20% | EC |

| Phyto- | | | | | |
|---|---|---|---|---|---|
| pathogenic | | | Appli- | Dura- | Evaluation |
| fungus | Sample | Doses | cation | tion | of efficacy |
| Monilinia | 1)Xedathane | Xedathane | Adding to | 5 | Growth |
| fructicola | 20 | 20: 250 ml/hl | the | days | inhibition |
| | 2)Bioxeda | Bioxeda: | artificial | | on Petri |
| | | 100 ml/hl | PDA | | dishes |
| | | 300 ml/hl | medium | | |
| | | 500 ml/hl | (potato | | |
| | | 1000 ml/hl | dextrose | | |
| | 3)Xedathane | Xedathane 20 + | agar) | | |
| | 20 + | Bioxeda: 250 | | | |
| | Bioxeda | ml/hl + 100 | | | |
| | | ml/hl | | | |
| | | 250 ml/hl + | | | |
| | | 300 ml/hl | | | |
| | | 250 ml/hl + | | | |
| | | 500 ml/hl | | | |
| | | 250 ml/hl + | | | |
| | | 1000 ml/hl | | | |

### Description of the Methods:

| Microrgan- | | | Culture | Répli- | Growth | Incu- |
|---|---|---|---|---|---|---|
| ism | Method | Diluent | medium | cations | conditions | bation |
| Monilinia | Inocula- | Physio- | PDA, | 4 | 25° C. ± | 5 to 6 |
| fructicola | tion. | logical | | | 1° C. | days |
| | | solution | | | | |

### Analysis:

The samples were added to the artificial medium and were mixed gently prior to the solidification of the agar solution.

Efficacy against Monilinia fructicola:

A small quantity of fungal spores was placed at the centre of the potato dextrose agar (PDA) in Petri dishes at 25±1° C. for 5-6 days. At the end of the incubation, the inhibition of the halo formed was measured, compared with untreated PDA Petri dishes (control).

### Evaluation of the Results:

The results are expressed as the percentage of incidence of the infestation, and the percentage of efficacy of the product tested.

Monilinia fructicola

### Samples:

Xedathane 20
Bioxeda
Xedathane 20+ Bioxeda

| Phyto- | | Incidence of | | | |
|---|---|---|---|---|---|
| pathogenic | | infestation | Efficacy | | |
| fungus | Sample | (%) | (%) | Dose ml/hl | |
| Monilinia | Untreated | 100 | 0 | | |
| fructicola | Xedathane | 5 | 95 | 250 | ml/hl |
| | 20 | | | | |
| | Bioxeda | 75 | 25 | 100 | ml/hl |
| | | 70 | 30 | 300 | ml/hl |
| | | 30 | 70 | 500 | ml/hl |
| | | 20 | 80 | 1000 | ml/hl |
| | Xedathane | 0 | 100 | 250 + 100 | ml/hl |
| | 20 + | 0 | 100 | 250 + 300 | ml/hl |
| | Bioxeda | 0 | 100 | 250 + 500 | ml/hl |
| | | 0 | 100 | 250 + 1000 | ml/hl |

Monilinia fructicola—Strain Resistant to Pyrimethanil:

### Samples:

Xedathane 20
Bioxeda
Xedathane 20+ Bioxeda

| Phyto- | | Incidence of | | | |
|---|---|---|---|---|---|
| pathogenic | | the infestation | Efficacy | | |
| fungus | Sample | (%) | (%) | Dose ml/hl | |
| Monilinia | Untreated | 100 | 0 | | |
| fructicola | Xedathane | 55 | 45 | 250 | ml/hl |
| strain resis- | 20 | | | | |
| tant to | Bioxeda | 30 | 70 | 100 | ml/hl |
| pyrimethanil | | 20 | 80 | 300 | ml/hl |
| | | 25 | 75 | 500 | ml/hl |
| | | 20 | 80 | 1000 | ml/hl |
| | Xedathane | 10 | 90 | 250 + 100 | ml/hl |
| | 20 + | 5 | 95 | 250 + 300 | ml/hl |
| | Bioxeda | 3 | 97 | 250 + 500 | ml/hl |
| | | 5 | 95 | 250 + 1000 | ml/hl |

Monilinia fructicola fungus was present in 100% of the Petri dishes that were untreated.

### Results:

Monilinia fructicola:

Clove oil in combination with pyrimethanil allowed complete control of the fungus at all of the doses tested.

Monilinia fructicola, Strain Resistant to Pyrimethanil:

Pyrimethanil provided an efficacy of only 45%, while the combination of clove oil and pyrimethanil provided nearly complete control at all doses tested.

1-17. (canceled)

18. A solution of pyrimethanil characterised in that it comprises pyrimethanil and one essential oil which is clove oil and/or the active terpenic agent which is a constituent of such oil, eugenol.

19. The solution of pyrimethanil according to claim 18, characterised in that it comprises:
between 5 and 40 wt. % of pyrimethanil;
between 10 and 95 wt. % of clove oil and/or eugenol.

20. The solution according to claim 18, comprising in addition one or more solvents, wetting agents, emulsifiers.

21. The solution according to claim 18, comprising one or more emulsifiers.

22. An emulsion comprising pyrimethanil, clove oil and/or eugenol, in water.

23. The emulsion according to claim 22, comprising a solution of pyrimethanil which comprises pyrimethanil and one essential oil which is clove oil and/or the active terpenic agent which is a constituent of such oil, eugenol, in emulsion in water.

24. The emulsion according to claim 22, wherein the concentration of said solution is comprised between 100 and 5000 g of pyrimethanil per cubic metre.

25. The emulsion according to claim 22, comprising pyrimethanil in an amount of 0.0025 to 2 wt. %, clove oil and/or eugenol in an amount of 0.005 to 4.75 wt. %, and water in an amount of 93.25 to 99.9925 wt. %.

26. A kit comprising pyrimethanil, clove oil and/or eugenol, and optionally water and/or one or more emulsifiers, for simultaneous application.

27. A process of fungicidal treatment of crops in the orchard, or post-harvest, comprising the application of a solution according to claim 18.

28. A process of fungicidal treatment of crops in the orchard, or post-harvest, comprising the application of an emulsion according to one of claim 22.

29. A process of treatment according to claim 27, by thermonebulization, sprinkling, and/or immersion.

30. A process of treatment according to claim 27, wherein pyrimethanil is applied at doses between 2 and 20 g/ton of fruits.

31. A process of preparation of a solution according to claim 18, which comprises mixing its constituents.

32. A process of preparation of an emulsion according to claim 23, which comprises placing the solution in suspension in water.

33. The solution according to claim 19, comprising one or more emulsifiers.

34. The emulsion according to claim 23, wherein the concentration of said solution is comprised between 100 and 5000 g of pyrimethanil per cubic metre.

35. The emulsion according to claim 23, comprising pyrimethanil in an amount of 0.0025 to 2 wt. %, clove oil and/or eugenol in an amount of 0.005 to 4.75 wt. %, and water in an amount of 93.25 to 99.9925 wt. %.

36. A process of fungicidal treatment of crops in the orchard, or post-harvest, comprising the application of a solution according to claim 19.

37. A process of fungicidal treatment of crops in the orchard, or post-harvest, comprising the application of an emulsion according to one of claim 23.
